(19) United States
(12) Patent Application Publication
(10) Pub. No.: US 2015/0244245 A1
(43) Pub. Date: Aug. 27, 2015

(54) CONTINUOUS ACTION, SELF-OPERATING MULTI-VOLTAGE ELECTRICITY PRODUCING UNIT AND METHODOLOGY

(71) Applicant: Richard UYS, La Porte, TX (US)

(72) Inventor: Richard UYS, La Porte, TX (US)

(21) Appl. No.: 14/632,828

(22) Filed: Feb. 26, 2015

Related U.S. Application Data
(60) Provisional application No. 61/944,797, filed on Feb. 26, 2014.

(51) Int. Cl. H02K 47/00; H02J 5/00; H02J 7/00

(52) U.S. Cl. CPC H02K 47/00; H02J 7/0068; H02J 5/00; Y10S 74/09; H02K 53/00

(57) ABSTRACT

An apparatus and method provides off grid electricity in multiple forms and electric power levels to provide a plurality of levels of electricity to be used to power many levels of electricity simultaneously.

### CLAIM FOR PRIORITY AND CROSS REFERENCE

This application relies for priority on U.S. Provisional Patent Application Ser. No. 61/944,797, entitled “Continuous Action, Self-Operating Multi-Voltage Electricity Producing Apparatus,” filed on Feb. 26, 2014, the entirety of which being incorporated by reference herein.

### FIELD AND BACKGROUND

The present disclosure relates to power generation.

### SUMMARY

According to the present disclosure, disclosure pertains to an apparatus for providing off grid electricity in multiple forms and electric power levels.

In accordance with at least one disclosed embodiment, an apparatus is configured to produce automatic variable voltage power output to a large, specially designed, industrial grade, voltage governing, power regulator that is configured to send power through a very large, in-line, industrial size fuse, set up to four linked up heavy duty deep cycle batteries (although it should be understood that this may be any number of a plurality of batteries).

In accordance with such an embodiment, the resulting newly created automatic variable dynamo power voltage and multi-function voltage power set up, and the large in line fuse enable a perfect constant forward and backward analysis in order to balance power to the batteries, in that the batteries have to provide the constantly changing desired power levels to the large multi-level operation power inverter(s).

In accordance with such an embodiment, the multi-variable power super-inverter is configured to provide a plurality of levels of electricity to be used to power many levels of electricity simultaneously.

Additional features of the presently disclosed embodiments will become apparent to those skilled in the art upon consideration of illustrative embodiments exemplifying the best mode of carrying out the disclosure as presently perceived.

### BRIEF DESCRIPTION OF THE FIGURES

A complete understanding of the subject invention will be obtained when the detailed description is considered together with the accompanying drawings, in which:

FIG. 1 is an example of power generation unit provided in accordance with at least one disclosed embodiment.

FIG. 2 is an example of the interconnection of constituent components of a power generation unit provided in accordance with at least one disclosed embodiment.

FIG. 3 is an example of the interconnection of constituent components of a power generation unit including a single inverter, four batteries a single PMD and a single AC motor provided in accordance with at least one disclosed embodiment.

FIG. 4 is an example of the interconnection of constituent components of a power generation unit including two inverters, six batteries, two PMDs and a single AC motor provided in accordance with at least one disclosed embodiment.

FIG. 5 is an example of the interconnection of constituent components of a power generation unit including two inverters, eight batteries, three PMDs and a single AC motor provided in accordance with at least one disclosed embodiment.

FIG. 6 is an example of the interconnection of an AC motor and PMD coupled together in accordance with at least one disclosed embodiment.

FIG. 7 is an example of the interconnection of an AC motor and PMD coupled together in accordance with at least one disclosed embodiment.

FIG. 8 is an example of the interconnection of an AC motor and two PMDs coupled together in accordance with at least one disclosed embodiment.

FIG. 9 is an example of the interconnection of an AC motor and three PMDs coupled together in accordance with at least one disclosed embodiment.

FIG. 10 is an example of the interconnection of two AC motors and one PMD coupled together in accordance with at least one disclosed embodiment.

FIG. 11 is an example of the interconnection of a PMD and an AC motor via a set of gears.

FIG. 12 is an example of the interconnection of a PMD and an AC motor via a plurality of drive belts.

FIG. 13 illustrates an example of a methodology for operation of the disclosed embodiments and how this constant feedback exchanged among the components of the apparatus may be used to control their respective operations

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

Throughout the world there is a need for production of electric power. Conventionally, electric power generation is performed from other sources of primary energy including coal, oil, and natural gas. Electric power is often generated at a power station by electromechanical generators, primarily driven by heat engines fueled by combustion, nuclear fission, etc. The electric power is then transmitted along power lines for distribution or storage and subsequent use by industrial, commercial or residential consumers.

The disclosed embodiments provide an alternative to this conventional power generation and transmission by providing off grid electric power. The electric power may be provided to a predetermined or chosen facility or facilities without the need for a large power transmission or distribution system. Thus, the disclosed embodiment provide an apparatus for the generation of electric power that may be used individually or as part of a farm of such apparatuses to provide power to remote locations that where power has not or is not readily accessible.

According to the presently disclosed embodiments, electric power generation apparatuses may be implemented as continuous operation, internally automated, self-powering electricity producing apparatuses. Such apparatuses may be used to provide electric power to a building, a particular function, e.g., pumping flood water, a facility, for example, a water treatment plant, or station, e.g., a telecommunications base station. Likewise, a farm (or plurality of such apparatuses may be used to provide electric power to numerous buildings, or to various forms of work action areas, or to large open or enclosed areas. Disclosed embodiments provide continuous, automated, internally-created, electric power that may be simultaneously output in multiple forms and at multiple levels.

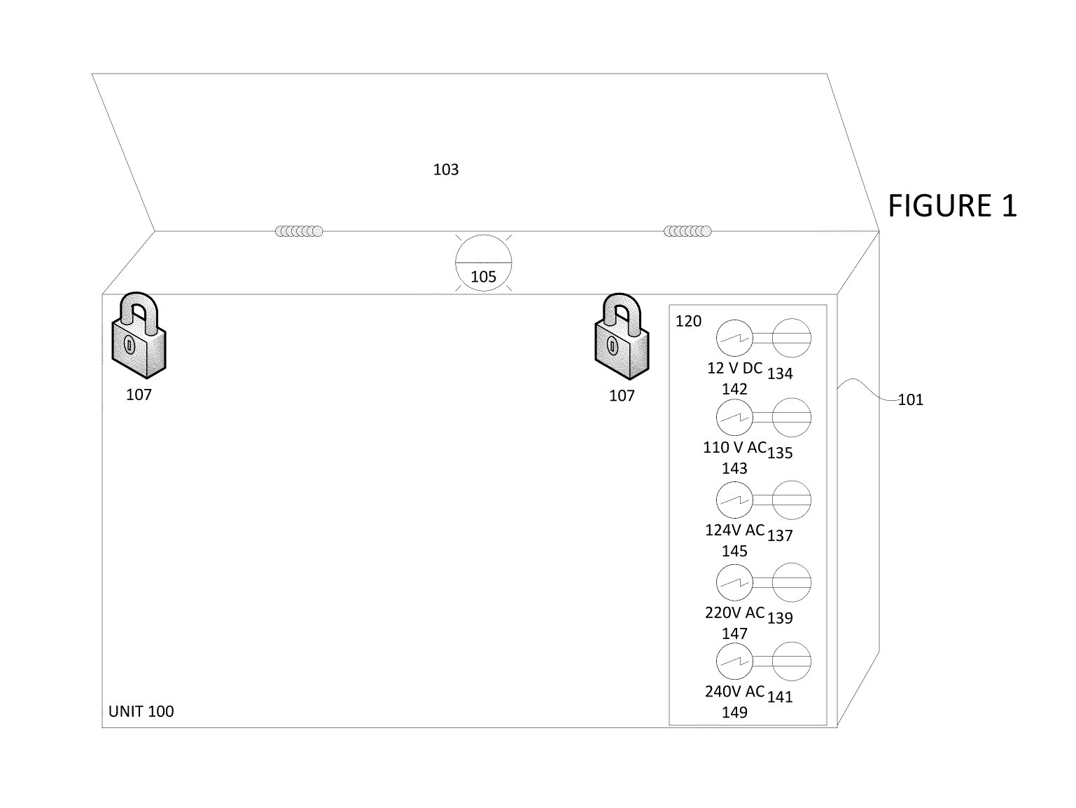

FIG. 1 is an example of power generation unit provided in accordance with at least one disclosed embodiment. FIG. 1 is a perspective view of a housing 101 for a power generation unit apparatus 100. FIG. 1 illustrates one example of a configuration of the housing 101 of an apparatus 100, which may be implemented from metal, wood or plastic with a hinged or unhinged top cover 103. As illustrated in FIG. 1, the top cover 103 may be optionally lit by an illumination assembly 105 to provide illumination to components within the housing 101.

The housing 101, optionally, may be separated into separate compartments, for example, for compartments associated with the batteries, DC power generation components, inverter and meters and associated power outlets.

The light assembly 105 may be included because disclosed embodiments may be implemented to provide a completely enclosed, self-generation, self-operation continuous operation device that does not need any external fuel or energy, e.g., engine, fuel power, sunlight, water, steam, wind, etc.; accordingly, the device can operate in remote areas such as in a desert, on the Polar regions, and even buried in the ground with only the cables protruding above ground. However, in such areas, there may be little or no light by which to see the components included in the housing 101. Thus, in accordance with at least one embodiment, an internal light assembly 105 is provided and is powered by the cooperation of the other components included in the housing 101, as explained herein.

Additionally, the housing 101 may include one or more of a plurality of locks 107 and a lower body portion 109 that mates with the cover 103 to provide a complete housing container 101. As a result of actuation of the lock(s) 107, the components of the housing 101 are secured therein. It should be further understood that the locks 107 may be unlocked by an engineer or maintenance personnel who may be uniquely permitted/able to replace a fuse within the unit. It should be further understood that the unit 100 may be further secured by placing the unit housing 101 underground with only the cables protruding above ground; in such a construction, the housing 101 may be further placed underneath a cement slab to further deter theft of the unit and its components.

The housing 101 may also include, on an exterior of the housing 101, electrical power outlets 134, 135, 137, 139, 141 corresponding, respectively to voltage meters 142, 143, 145, 147, 149. These outlets are configured to enable access to power generated at the respective levels. For example, outlet 134 provides access to generated power at 10V DC. Outlet 135 provides access to generated power at 110V AC. Outlet 137 provides access to generated power at 124V AC. Outlet 139 provides access to generated power at 220V AC. Outlet 141 provides access to generated power at 240V AC. Likewise, the meters 142, 143, 145, 147, 149 may optionally be provided on the outside of the housing 101 to indicate the level of power being generated by the unit 100 and/or delivered via the corresponding outlets.

It should be understood that the full power limit of power that may be generated at any given time will depend on the constituent components included in each unit 100, as explained herein. Thus, optionally, if a full power limit is close to being reached by apparatuses coupled to the unit 100 through the outlets, a warning alarm may be generated or sounded to prevent abuse of the apparatus' maximum set output;. For example, the meter corresponding to the electric power outlet may be controlled to flash a bright red warning light indicating a need to reduce consumption of the provided electricity. Should a user not obey the warning, the unit 100 may be configured to shut down. In accordance with at least one embodiment, this may result in an area service engineer being required to reset or replace an optionally included safety factor inline power voltage protection fuse within the apparatus. Optionally, that engineer may be uniquely able to replace that fuse because the engineer may be the only one with a set of keys to unlock locks securing the contents of the apparatus housing.

The housing 101 may be configured to include openings for bringing in outside air into the housing 101 through a range of potential selection of filters (not illustrated) depending upon the need for ventilation, cooling, and the environment in which the unit 100 is placed, etc. Thus, the housing 101 may have an opening whereby a fan or blower exhausts air from within the box to the outside area through a hole through a selected range of filters suitable depending upon where and how the apparatus is being used. Accordingly, it should be understood that a number of blowers or fans may be included in the apparatus 100 and used to move air into and out of the housing 101 via a hole cut through in housing 101.

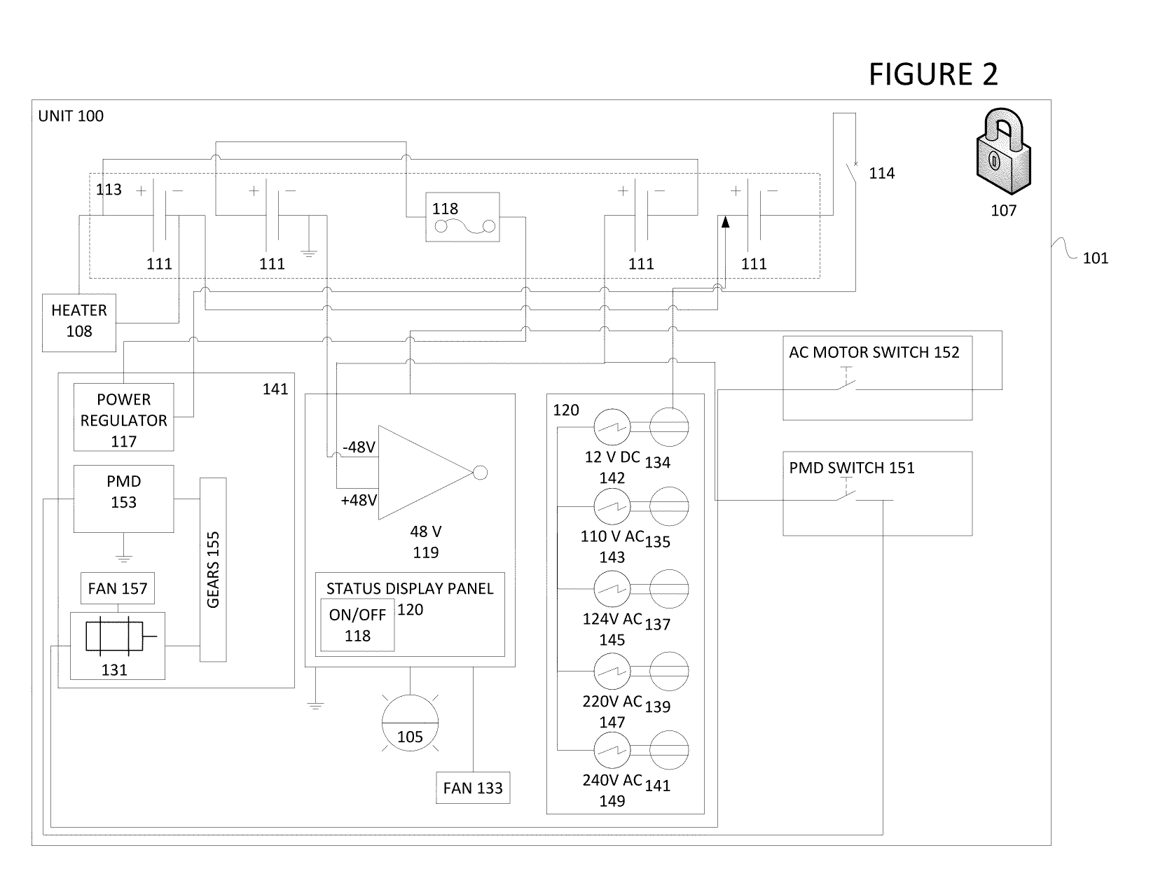

FIG. 2 is an example of the interconnection of constituent components of a power generation unit provided in accordance with at least one disclosed embodiment.

The housing 101 may contain a metal, plastic, wooden or fiberglass nonadjustable motor mount plate 104. Additionally, the housing 101 may contain an adjustable motor mounting bracket 106 to accommodate various size belts or tooth cogs.

The apparatus may optionally include one or more (e.g., four) heaters 108 that may be controlled to work on automatic scale up increments depending on a demand for warm air to compensate for extreme polar region air temperatures.

FIG. 2 is a mechanical schematic diagram of a disclosed embodiment. As illustrated in FIG. 2, the disclosed embodiments of the apparatus 100 may further include a circuit bridge connector 109 that when turned on to be operational, enables one or a plurality of batteries 111 placed in a battery-holding tray 113 to be activated. More specifically, the battery or batteries 111 may become activated by engaging the bridge connector 109 by activating a switch 115 from an off position to an on position.

As a result of this activation, the battery (ies) 111 may be engaged to provide battery power to an industrial power conversion regulator 117 to activate and regulate battery consumption levels (as explained in more detail herein). As a result, the battery power is transmitted through one of a plurality of specific suitable size industrial fuses included in an industrial power conversion unit 119 working either in singular or plural function to provide balanced usage and input power to the industrial power conversion unit 119 to both the positive pole side connection 121 of 119 and also completes circulatory power by connecting the power from negative pole side 123 from 111 to the negative connection pole of 119 to, thus, activate the industrial power conversion unit 119.

A 12 volt consumption usage indicator gauge 125 and to a 12 volt power outlet 127 are powered by batteries 111 to provide usable power to the 12 volt power outlet 127. Industrial power conversion unit 119 is configured to send electric AC power at various levels including 12, 48, 72, 96, 110, 220, or 240 volts via a cable 129 to engage one or more alternating current or direct current motors 131 of various different sizes including, 12, 24, 36, 48, 60, 72, and 96 volt power.

Disclosed embodiments are configured to provide electric power in numerous voltage power levels for an end user. No matter what the form of provided electricity (12, 110, 115, 125, 220, or 240 volt), gauges portray amounts of electricity being used.

The industrial power conversion unit 119 may also send a diverse range of electric power to various other components within the apparatus 100, including the output components 120, fan 133, light 105, etc. Output components 120 may include, for example, power outlets 135, 137, 139, 141 and gauges 143, 145, 147 and 149. In this way, the industrial power conversion unit 119 is configured to output electric power at various levels ranging from 12-240 volts (including at least voltage levels 12, 110, 125 volt, 220 and 240 volts.

Power control switch 151 may be configured and coupled to activate one or more Permanent Magnetic Current Dynamos (PMDs) (which may be replaced with alternators as understood by one of ordinary skill in the art) to generate voltage power.

It should be understood that a PMD produces direct current with the use of a commutator, wherein rotating coils of wire and magnetic fields are used to convert mechanical rotation into a pulsing direct electric current through Faraday's law of induction. Thus, a PMD may include a stationary structure, called the stator, which provides a constant magnetic field, and a set of rotating windings called the armature which turn within that field; the motion of the wire within the magnetic field causes the field to push on the electrons in the metal, creating an electric current in the wire.

The battery breaker 114 may be provided to connect or disconnect power to charge the batteries 111 from the power regulator 117.

AC motor switch 152 may be configured and coupled to activate the one or more AC motors 131.

The multi-level power designed unit may be configured to enable output of power between 10 and 1,200 amps. The super-power, multi-function, constant variable PMD 153 can operate at 12, 24, 36, 48, and/or 96 volts automatically based on a voltage power demand from the power regulator 117. That power regulator 117 may implemented to include a specially designed, multi-power reading, internal computer module, which is configured to send demanded power from the multi-function, variable PMD 153 (e.g., at 12, 24, 36, 48 and 96 volts) automatically through the conversion unit 118. The conversion unit 118 includes a large, industrial, in-line fuse and is coupled to the plurality of large, deep cycle batteries 111.

Constant forward and feedback calculation demand and supply balance ensure that the variable PMD can operates automatically and simultaneous power on demand. This balance is controlled by an incorporated computation and control module that is implemented as specially constructed, computer controlled, multi-reading internal computer module governing device that controls the interconnected high capacity regulator. The high capacity regulator 117 receives sends demand and supply data through the power conversion unit 118 to serve the large battery bank 111 demands to keep the multi-variable super-inverter 119 supplied with the correct voltage demand.

The inverter(s) 119 may be implemented as a multi-variable power, super-inverter configured to provide a plurality of levels of electricity to be used to power many levels of electricity simultaneously. Although inverters are conventionally known having a maximum of approximately 10,000 watts and about 70 amps, the disclosed embodiments can produce an average of 30,000 watts (at about 250 amps) with large variations producing 60.000 watts (at about 400 amps and, potentially, 800 amps). Thus, conventional inverters are insufficient for the power requirements of the disclosed embodiments. Moreover, conventional inverters are also limited to single electrical output current whereas the presently disclosed embodiments of the apparatus enable multiple electrical outputs.

Controlling the balance of these components requires that the computation and control module included in the power regulator 117 to perform over a hundred calculations per second in order to keep the entire total self-contained, self-generating apparatus functioning on a perfect balanced scenario on a continuous operational basis.

Thus, disclosed embodiments are configured to operate based on constant, multi-level continual feedback between the multi-function variable PMD and batteries, and the multi-stage demand from the multi-voltage computer controlled power inverter. The cooperation of these components enables total-package efficiency function and balance of the entire power balance demand electrical operation.

It should be understood that, although many of the components used to provide the inventive apparatus have and are used in numerous industrial products, the disclosed apparatus is unique because all components are configured to operate in a completely balanced manner so as to operate effectively. The disclosed embodiments utilize powering components that are all in proper sync to provide required power demand.

Likewise, as power demand changes, the inventive apparatus is configured to meet the demand change while still maintaining the constituent components of the apparatus in synchronization.

By way of analogy only, and to better understand the requirements of such synchronization, consider a conventional automobile vehicle as a comparison to the disclosed inventive concept. When the vehicle is commanded to climb a steep hill, the power governing components of the vehicle sends a message to the power controlling mechanisms indicating the vehicle is now being commanded added stress. As a result, the transmission, fuel intake and battery output is adjusted to enable the vehicle to attain a more suitable balanced status. The transmission is downshifted to a lower gear so the vehicle can climb the hill comfortably without excess strain on the engine in conjunction components; the demand on the battery is also increased. As a result, the regulator is controlled to provide more voltage input to the battery to compensate for the added demand. Further, a fuse system is also put under added strain and as it is powered up and a balance regulator indicates to the alternator that more power is required. In turn, the alternator sends more power to the battery. Subsequently, a message is sent to the regulator indicating that balanced efficiency has been restored and the regulator controls the alternator to maintain power at a present level until further instructions are received. As a result of this conventional cooperation, a vehicle battery performs better in that the battery is maintaining its required power level, the fuel (e.g., gas, diesel) has leveled off to the engine's demand at that time, the engine dictates to the transmission to remain in a present gear.

Once at the top of a hill, the road will level off, or may get steeper, or proceed on a downward trend whereby the vehicles entire operating mechanism put out new adjusted demands including the power regulator that controls the battery balance and the alternators desired output. In this way, the vehicle reads all the altered status and continues to pass on signals in order to keep the vehicle in perfect balance.

In the same way, disclosed embodiments of the inventive apparatus include a plurality of interconnected components that work in combination to provide a balanced system that dynamically responds to a demand placed on the apparatus.

Power generated by the power current alternators 153 (and/or one or more permanent magnet power current dynamos may be generated at various levels ranging from 12-96 volts (including voltage levels of 12, 24, 36, 48, 60, 72 and 96 volts).

Although not illustrated, it should be readily understood by one of ordinary skill in the art that the batteries 111 may in fact be battery assemblies that include one or more relays that read the voltage level of the batteries 111, to enable formulation of instructions to the PMDs 153 using command and control functionality implemented in the inverter 119 and/or regulator 117.

The alternating or direct electric power motor 131 may be designed to use multiple drive gear sizes working in conjunction with one of a range of driven gears 155 to determine the amount of required voltage power ranging from 6-96 volts (including voltage levels of 6, 12, 24, 48, 72 and 96 volts). The PMDs 153 send power to battery(ies) 111 to provide power thereto. Disclosed embodiments of the unit 100 may include, for example, a 12 volt DC battery that may be used to input power to a single inverter to produce 110, 125, 220 and 240 volts AC. Likewise, in another example, two 12 volt DC batteries providing a total of 24 volts DC may be used to input power to a single inverter to produce 110, 125, 220, and 240, 360 or 480 volts AC. Further, in other implementations, a single inverter may produce 110, 125, 220, and 240, 360 or 480 volts AC using three, four, five, six, seven and eight batteries (providing 36, 48, 60, 72 and 96 volts DC, respectively).

In fact, it should be understood that there is an almost unlimited number of battery combinations wherein a plurality of batteries may be used to provide required levels of voltage and current and types (e.g., DC, AC, etc.,)

The apparatus 100 may further include a frame mounted separate fan 157 configured and positioned to cool multi-function variable PMD 15. Additionally, although not illustrated, an electric motor on shaft fitted propeller fan blade may be incorporated to cool the AC motor 131

In accordance with various embodiments, units may be configured using different components to provide different types and levels of power. In accordance with at least one embodiment, the apparatus may be configured to provide power using a single inverter. Thus, for example, a single phase, 12, 24, 110, 220, 380 or 480 V electric motor may be used to drive a single PMD. Thus, one or two single phase 110 or 220 volt continuous operation AC motors may be used to drive the three PMDs 153. Alternatively, the unit 100 may be configured to use a single three-phase 380 or 480 volt continuous operation electric motor to drive three or four PMDs. Additionally, two single phase 220 volt continuous operation electric motors may be used to drive four PMDs as well. Further, the apparatus may be configured to use one three phase 380 volt continuous operation electric motor to drive three PMDs. Likewise, use of two three phase 480 volt continuous operation electric motors may be used to drive three PMDs.

Disclosed embodiments may provide electric power that may be simultaneously output in multiple forms and at multiple electrical power levels. As is conventionally known, electricity may be generated by the movement of a loop of wire, or disc of copper between the poles of a magnet. Using this conventionally known relationship, electric power utilities around the world produce electric power.

However, to the contrary, disclosed embodiment provide an inventive unit that outputs automatic, variable voltage, power output to a large, industrial grade, voltage governing, power regulator that is configured to send power through a very large, in-line, industrial size fuse to charge a plurality of linked, heavy duty deep cycle batteries. Components of the unit enable a perfect constant forward and backward analysis balance of power to the batteries, in that the batteries provide a constantly changing desired power level to the large multi-level operation power inverter(s) and power demands attached to the unit.

Disclosed embodiments provide a versatile power generation apparatus because the apparatus can provide numerous different levels of electricity demand simultaneously. For example, consider a situation in which the apparatus is used to satisfy electricity demand for a worker using an arc welder on a work site at which other workers are also requiring electricity.

For example, a unit designed in accordance with the disclosed embodiments can power an arc welding machine, which when operating, draws 25,000 watts (at 100 amps) but when the welding rod is disengaged, requires only approximately, 2,000 watts (at 12 amps). In operation, as soon as the welding rod strikes a work surface again, in an instant 25,000 watts (at 100 amps) is demanded from the high-output multi-level inverter. However, the disclosed embodiments provide a unit configured to meet that demand. Additionally, other workers using equipment with other intermittent, electrical requirements (e.g., drilling machine, grinding machine, cooking equipment) can also be met by the disclosed apparatus simultaneously.

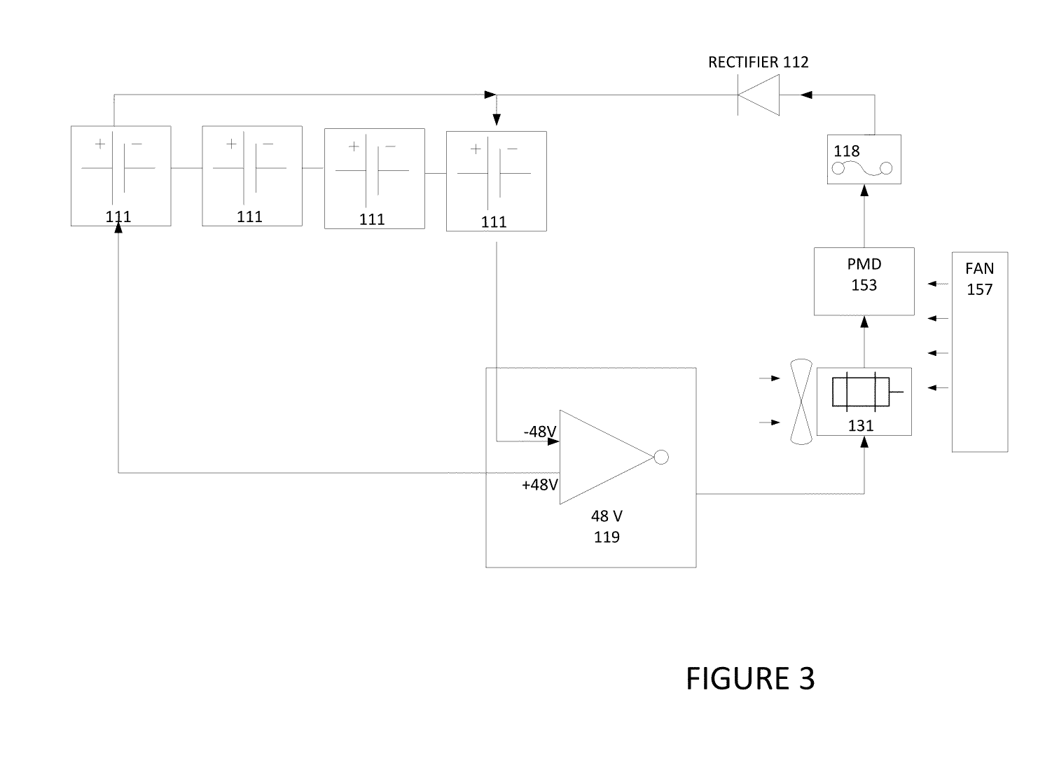

It should be understood that the components used to provide the disclosed embodiments may differ depending on the size and power level requirements of the unit. Thus, FIG. 2 illustrates a larger unit that utilizes an intelligent regulator/inverter combination. In the same way, FIGS. 3-6 illustrate smaller units that utilize an intelligent rectifier/invert combination.

FIG. 3 is an example of the interconnection of constituent components of a power generation unit 100 including a single inverter 119, four batteries 111, a single PMD 153 and a single AC motor 131 provided in accordance with at least one disclosed embodiment. The unit 100 may be configured to use one or more PMDs in conjunction with one or more batteries. For example, as shown in FIG. 3, one PMD 153 may be used to provide balanced power to one, two or four batteries. The unit 100 may be configured to use a single motor 131 (e.g., three-phase 110, 220, 380, or 480 volt continuous operation electric motor) to drive a single PMD 153. Alternatively, the unit 100 may be configured to use two, single phase 12 or 24 volt continuous operation electric motors 131 to drive a single PMD 153.

As shown in FIGS. 3-6 the unit components may include a rectifier 112 coupled between the fuse 118 and the bank of batteries 111. Such an implementation may be used for smaller units to replace the regulator 117 illustrated in FIG. 2. Accordingly, the rectifier 112 is configured to take in DC or AC current power and output electricity as DC (for example, to the batteries) or DC or AC (for example, to electrical outlets as explained in connection with FIG. 2). Therefore, it should be understood that the rectifier 112 may in fact be a rectifier assembly including control logic and/or a computer processor that enables balanced load and power generation.

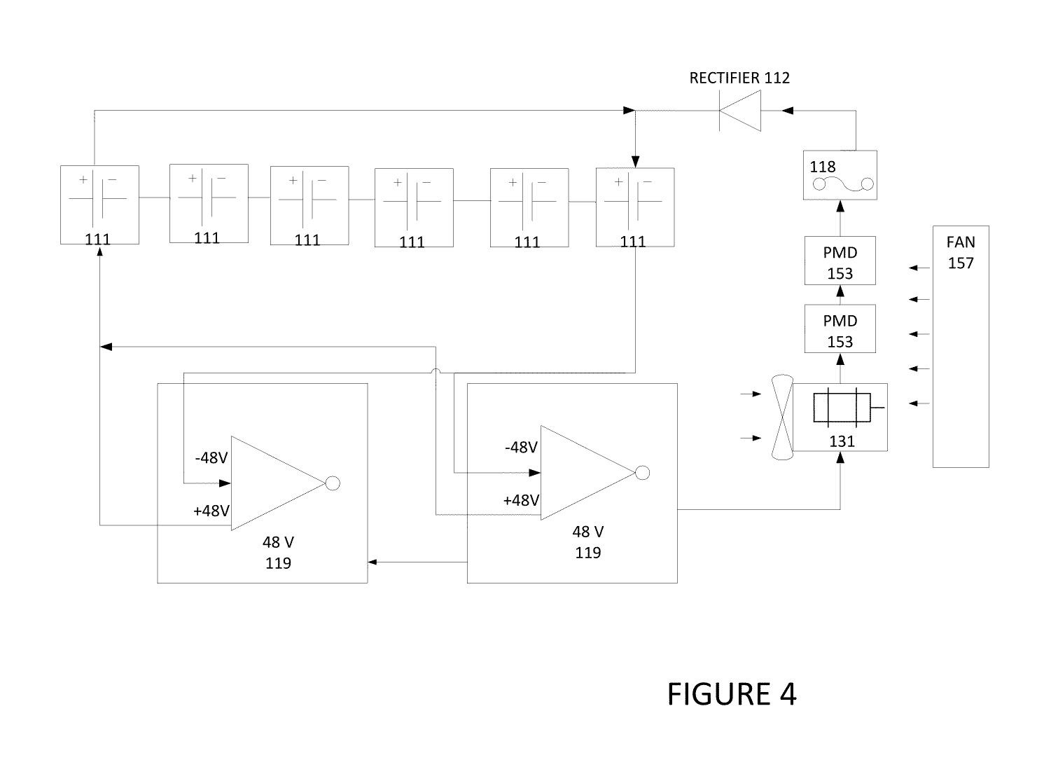

In accordance with at least one embodiment, the apparatus may be configured to provide multi-inverter operation. In such an implementation, for example, two eight 12 volt DC batteries providing 24 volts DC may be used to input power to two power inverters to produce 110, 125, 220, 240 360 or 480 volts AC. Likewise, the same multi-inverter operation is possible using four, five, six or eight batteries (providing 48, 60, 72 or 96 volts DC, respectively). FIG. 4 is an example of the interconnection of constituent components of a power generation unit 100 including two inverters 119, six batteries 111, two PMDs 153 and a single AC motor 131 provided in accordance with at least one disclosed embodiment. These multifunction high-power inverters are configured to produce multi-level types of electricity on a continuous basis.

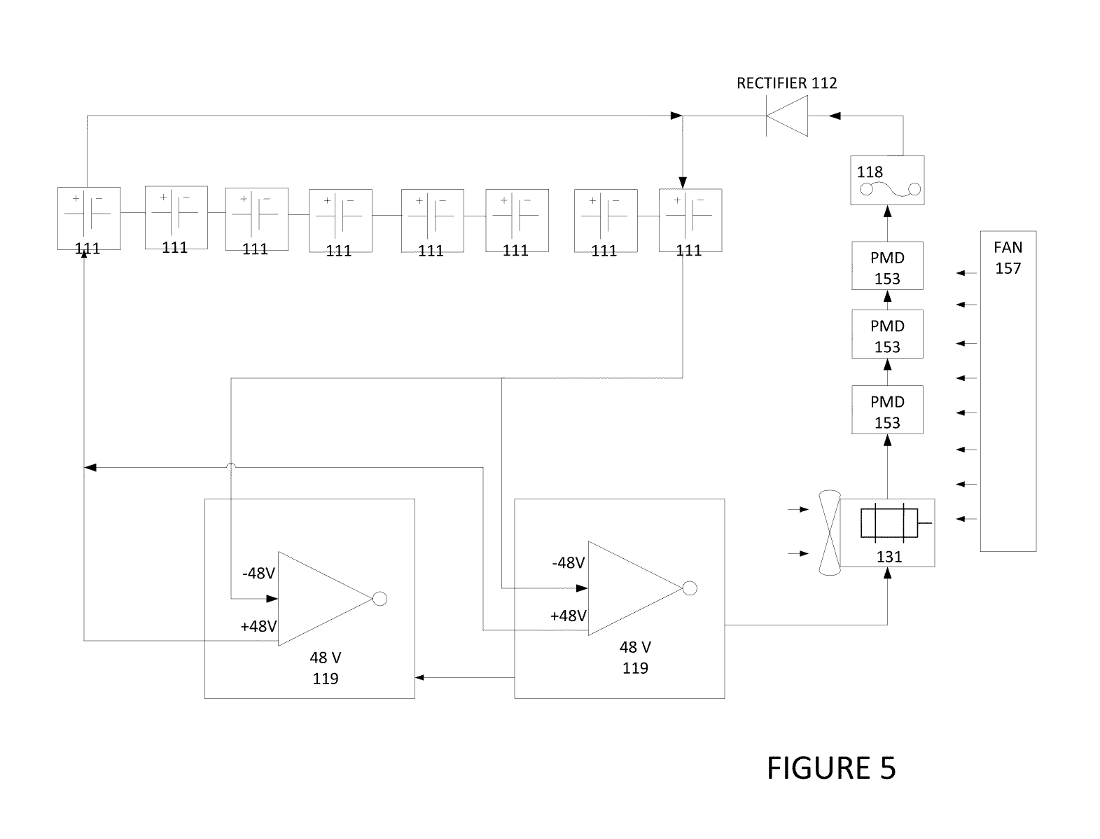

FIG. 5 is an example of the interconnection of constituent components of a power generation unit 100 including two inverters 119, eight batteries 111, three PMDs 153 and a single AC motor 131 provided in accordance with at least one disclosed embodiment.

In accordance with at least one embodiment, the apparatus includes at least one battery, and optionally, a plurality of batteries, that can vary in size, quantity, output models, composition structure, voltage type and voltage capacity. The at least one battery provides power to at least one, and optionally, a plurality of inverter transformers that, in turn, provide power, to power at least one, and optionally, a plurality of electric motors of various voltages located apart from the battery areas. The electric motors provide power to at least one, and optionally, a plurality of types of voltage motor electric generators to provide power to the generators.

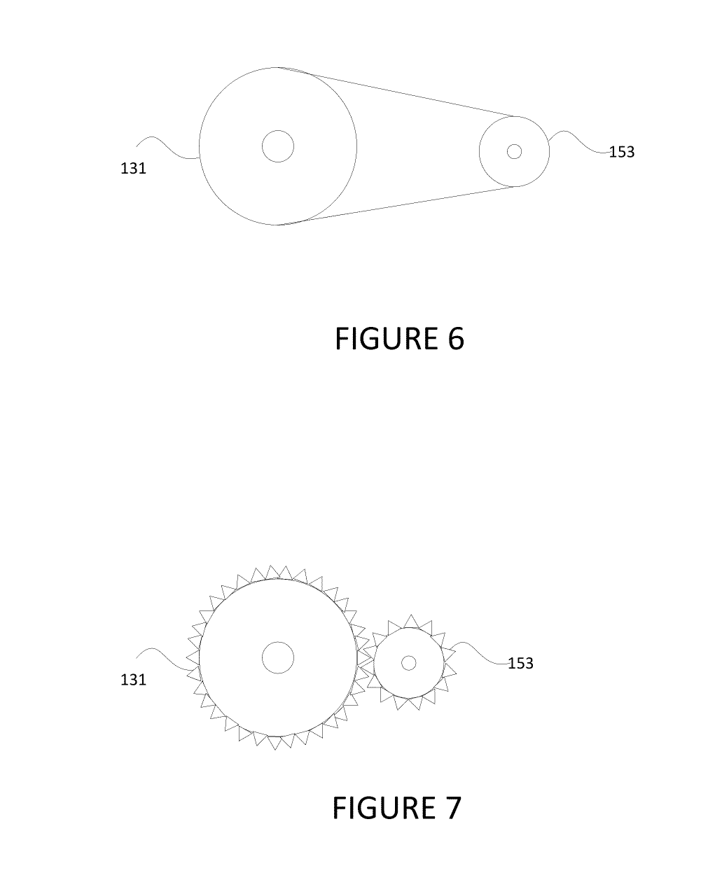

The electric motor(s) may drive operation of one or more PMDs, or Permanent Magnetic, automatic, multi-variable voltage Dynamos. FIG. 6 is an example of the interconnection of a single AC motor and a single PMD coupled together in accordance with at least one disclosed embodiment. Such an implementation may be used to generate power, for example, for a two battery bank, using a single phase motor coupled to a PMD via a single belt.

FIG. 7 is an example of the interconnection of a single AC motor and a single PMD coupled together in accordance with at least one disclosed embodiment. Such an implementation may be used to generate power, for example, for a four battery bank, using a three phase motor coupled to a PMD via a gear drive configuration.

Thus, it should be understood that the electric motor(s) may drive the PMD(s) by the electric motor's toothed cogs or belt pulley or link chain drive chain attached to the electric motor's drive shaft engaging the tooth cog or belt pulley or drive link chain with the use of a pulley type belt or drive link chain, or by round directly interconnected toothed cogs attached to the electric drive motor shaft to drive the one or more PMDs attached to the PMD's shaft.

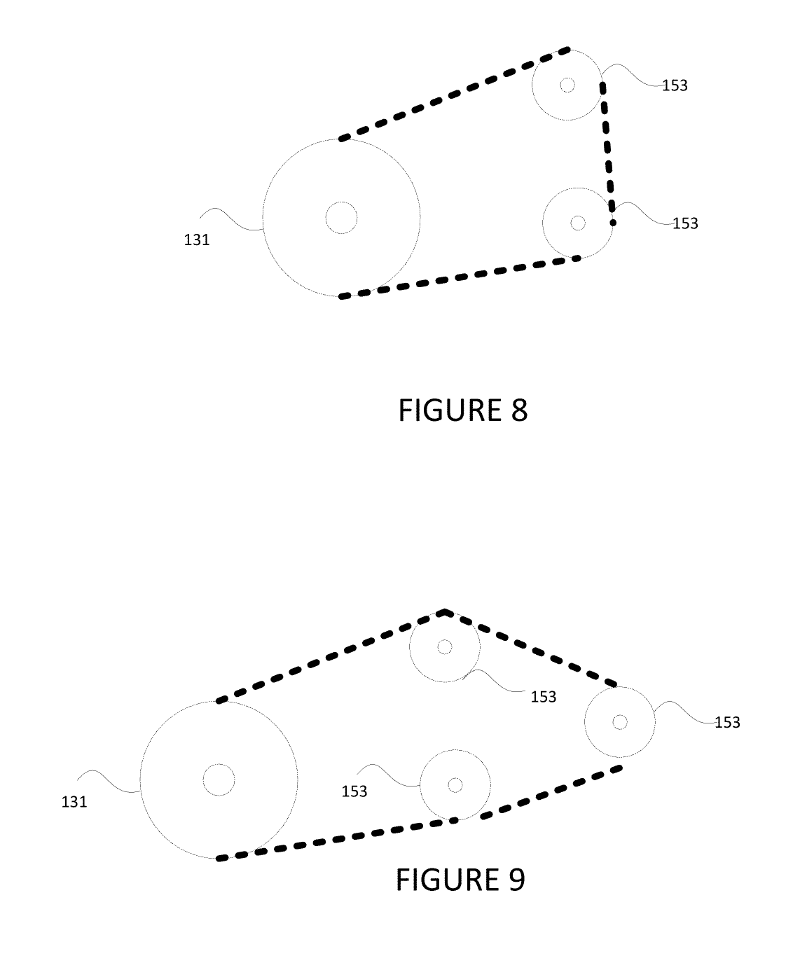

Thus, FIG. 8 is an example of the interconnection of an AC motor and two PMDs coupled together in accordance with at least one disclosed embodiment. Such an implementation may be used to generate power, for example, for a six battery bank, using a three phase motor coupled to the PMDs via a chain driven configuration. Similarly, FIG. 9 is an example of the interconnection of an AC motor and three PMDs coupled together in accordance with at least one disclosed embodiment for driving an eight batter bank using a chain driven configuration.

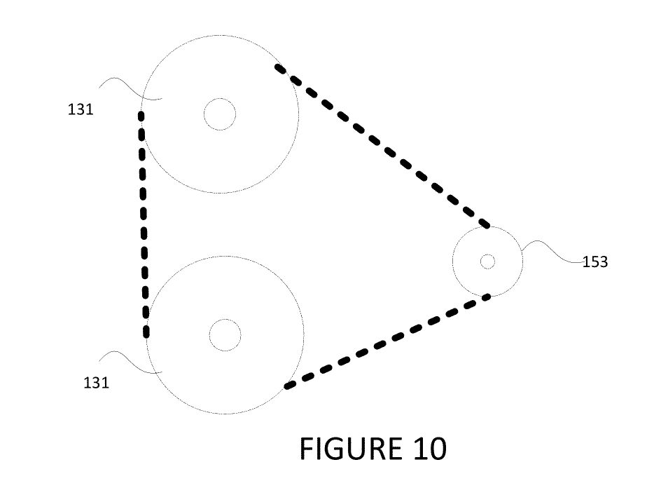

FIG. 10 is an example of the interconnection of two AC motors and one PMD coupled together in accordance with at least one disclosed embodiment. It should be understood that the disclosed embodiments can utilize various different numbers of PMDs and AC motors to provide different configurations of power levels.

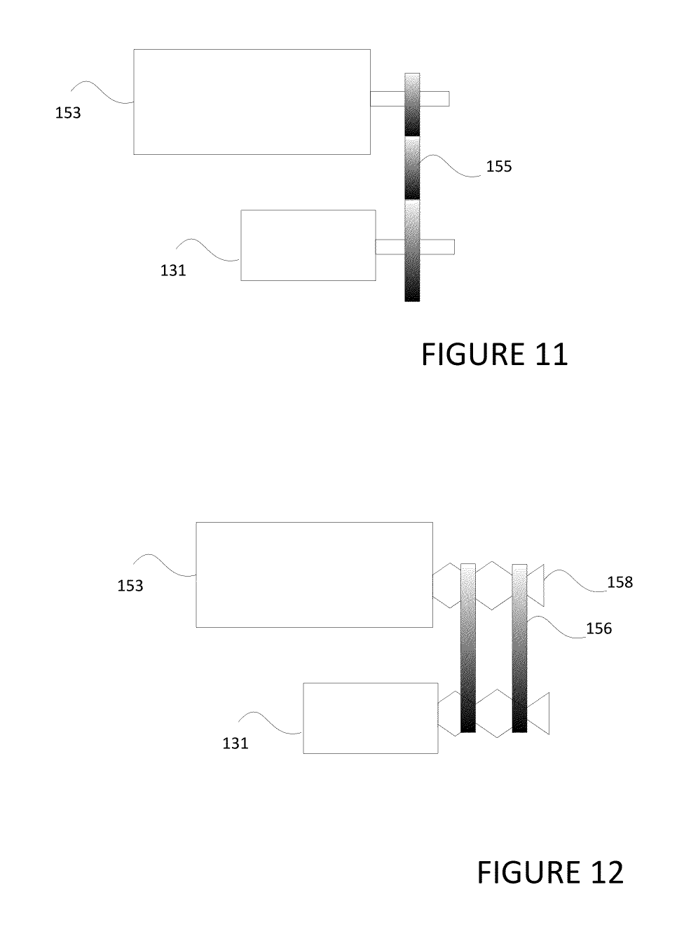

As explained above, the electric motor and dynamos gears or cogs can be replaced with adapted pulleys that may be turned by pulley belts in the operation thereof. Thus, FIG. 11 is an example of the interconnection of a PMD and an AC motor via a set of gears 155. Likewise, FIG. 12 is an example of the interconnection of a PMD and an AC motor via a plurality of drive belts 156, 158.

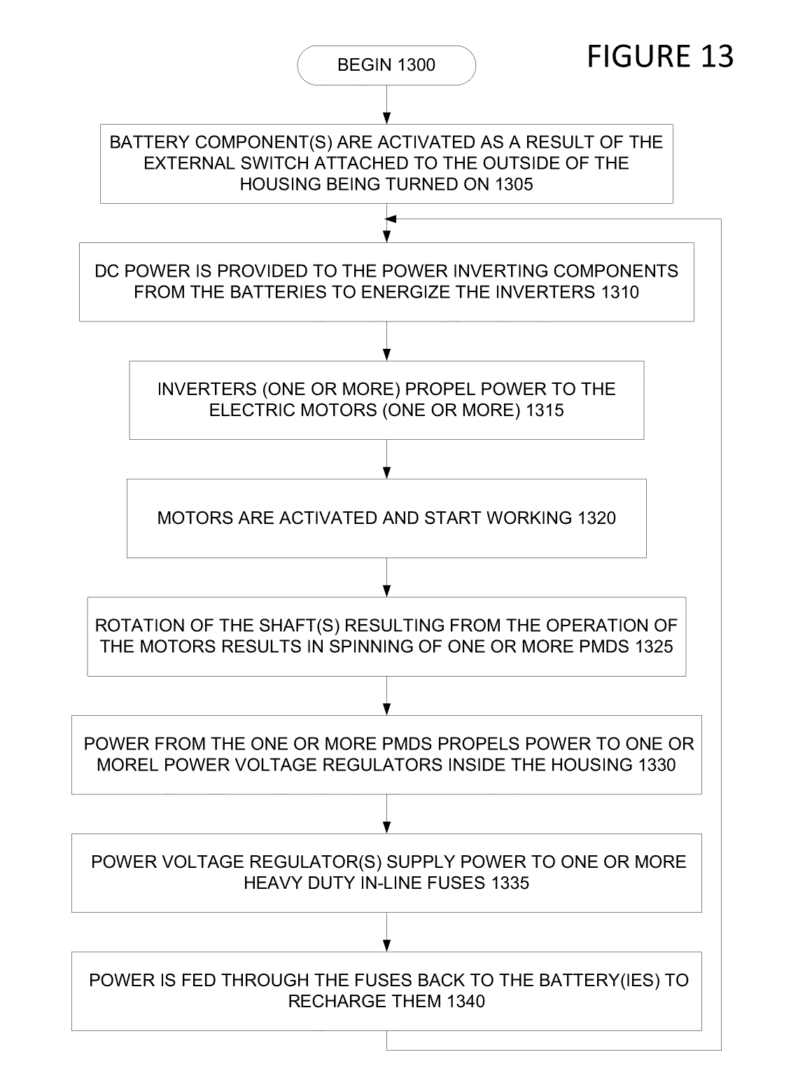

FIG. 13 illustrates an example of a methodology for operation of the disclosed embodiments and how this constant feedback exchanged among the components of the apparatus may be used to control their respective operations. This operation is possible because hundreds of electric power drawn variable are constantly fed back to the inverter that is constantly monitoring the batteries which are in constant communication with computation and control functionality that may be implemented in the power regulator 117, the inverter 119 or both (in combination). It should be understood that the computation and control unit and regulator are in constant communication with the variable, PMD 153, which transmits the right amount and type of voltage power on a constant basis.

In operation, the inventive concept may be thought of not only as an apparatus but a method for providing balanced power between components of the unit. Thus, FIG. 13 illustrates an example of a methodology for operation of the disclosed embodiments and how this constant feedback exchanged among the components of the apparatus may be used to control their respective operations. Control begins at 1300, and proceeds to 1305 at which the battery component(s) are activated as a result of the external switch attached to the outside of the housing being turned on. Control then proceeds to 1310, at which DC power is provided to the power inverting components from the batteries to energize the inverters. This is the first process to initiate the startup process. Subsequently, control proceeds to 1315, at which the inverters (one or more) propel power to the electric motors (one or more). As a result, at 1320, the motors are activated and start working. Rotation of the shaft(s) resulting from the operation of the motors results in spinning of one or more PMDs at 1325. The translation of the rotation of the motor shafts to the PMDs may be implemented in a number of different ways; for example, translation of the rotation may be provided with the use of the shaft connected gears, pulley fan belts, or pulley link chains.

Regardless of how the translation is implemented, at 1330, the power from the one or more PMDs propels power to one or more power voltage regulators inside the housing. As a result, the power voltage regulator(s) supply power to one or more heavy duty in-line fuses at 1335. In turn, that power is fed through the fuses back to the battery(ies) to recharge them at 1340. Control then returns to 1310 in that, the operation is continuous. Thus, although the operation has been described in a flowchart format, it should be understood that, once the unit is up and running, all of the operations are performed simultaneously. Moreover, data is being generated for the components and monitored by computation and control unit functionality implemented via computer processor provided in the power regulator and/or inverter assemblies to enable balance of the effects of each of these operations. Thus, the combined operations create a self-automating, continuous electric power production unit.

While this invention has been described in conjunction with the specific embodiments outlined above, it is evident that many alternatives, modifications and variations will be apparent to those skilled in the art. Accordingly, the various embodiments of the invention, as set forth above, are intended to be illustrative, not limiting. Various changes may be made without departing from the spirit and scope of the invention.

Further, it should be understood that the functionality described in connection with various described components of various invention embodiments may be combined or separated from one another in such a way that the architecture of the invention is somewhat different than what is expressly disclosed herein. Moreover, it should be understood that, unless otherwise specified, there is no essential requirement that methodology operations be performed in the illustrated order; therefore, one of ordinary skill in the art would recognize that some operations may be performed in one or more alternative order and/or simultaneously.

Embodiments of the present disclosure provide a solution to the technical problems of providing off-grid electrical power in potentially remote locations for extended periods of time. Disclosed embodiments can generate electric power on a continuous basis in total darkness and in isolation from external sources of power. Thus, units/apparatuses designed in accordance with the disclosed embodiments, may be located deep in a mine, buried in the ground, in polar ice regions where no sunlight is available for several months of the year, in a remote dessert etc.

Because the housing of a unit may be constructed of metal, plastic, wood, fiberglass or any other suitable material, the housing can be made to suit multiple application needs, including completely sealed housings that may be implemented for underwater operation placements such as seaside resorts, aqua biology research, reef studies etc.

Units can be buried underground and the internal created electrical power can be sent out above ground to power various electric powered apparatuses. As a result, such an implementation would prevent or dissuade the apparatus from being stolen or vandalized.

Disclosed embodiments provide internally-created electric power, wherein power is generated solely based on the internal components provided within a housing of the unit. Thus, the apparatus may operate to generate electric power without access to or use of solar panels, industrial manufactured gasses, petroleum fuels products, commercial fuel driven engine power generators, sunlight, or external electricity. Thus, the unit may operate to generate electric power without access to or use of solar panels, industrial manufactured gasses, petroleum fuels products, commercial fuel driven engine power generators, sunlight, or external electricity, disclosed embodiments may be configured to provide continuous electric power.

In accordance with disclosed embodiments, once the units are turned on (powered up), the unit can provides power at no cost until such time that the components are degraded to a point that proper balance between the batteries and power generation components cannot be sustained. It is estimated that, if properly configured and used, these units can run without external fuel or maintenance for at least five years and as much as seven years.

In some commercial applications, an internal temperature regulated cooling fan or blower may be used, or internal temperature regulated heating fan or blower may be necessary. Some embodiments of the unit can be placed in an airtight container for equipment safeguard reasons, or a water protected (rainwater protected) container. The unit can be bolted down from the inside of the housing area to concrete foundation to prevent theft of apparatus. Alternatively, a unit may be placed underneath a concrete slab, with protruding cables and, optionally, meters, for providing power of various types and levels. Likewise, the disclosed embodiments may provide an apparatus that can be weighted down internally to hinder removal. Units can be placed on a stationary platform or be set or fitted on a moving platform, or be installed in a moving vehicle (e.g., for land, sea, or air travel) while vehicle is stationary or in operation.

One or more thermostat temperature controlled blowers or fans inside the housing are used to bring air into the apparatus to balance the air quality within the housing and a single or plural blower exhausts the air from within the housing by thermostat temperature controlled blowers or fans through another selected area or areas of the housing. In the event where the apparatus may or is placed or buried underground, or placed in wet areas or placed underwater areas, internal fans and blowers are disengaged. Temperature control coolers or heaters may be placed within the sealed unit such that the unit may function without holes in the housing. In extreme cold or hot areas ambient areas, thermostat temperature controlled cooling air or heated air apparatuses may be incorporated and operated by computation and control software to control the balance of air inside the housing. At least some disclosed embodiments of the unit may contain an internal regulated heater or cooling system within the unit. The unit may be placed in a facility or facilities where a preferred type of internal quality of air control is required in order to enable the system function proficiently on a continuous basis.

Disclosed embodiments have the capacity to be the sole supplier of off grid electricity to a community or housing area, or to commerce and industrial complexes. Indeed, a single unit (or multiple units placed together as a power source farms) can provide a wide range of electrical power levels. Disclosed embodiments may be implemented to provide apparatuses/units of varying sizes and models designed to create solutions covering a wide range of diverse applications. More specifically, disclosed embodiments can generate and output electricity output that range from minute, off-grid, amounts of electricity for micro electricity applications to electricity required to power very large, systems capable of powering industrial facilities.

For example, a very small apparatus, weighing approximately 25 lbs. may be provided to produce 800 watts (5 amps) suitable for a small campsite. Such an implementation may be included in a housing approximately 18 inches long, 15 inches deep, and 12 inches high. Alternatively, a 7500 watts system (40 amps) may weigh approximately 100 lbs. and power a small mobile home/portable office, a small workshop or a large campsite, or average size rural African family dwelling and may be included in a housing approximately 24 inches long, 18 inches deep and 16 inches high. Further, a 30.000 watts system (250 amps) may provide adequate power to an average size American household, or a large African group village with a small repair shop industrial complex; such an implementation may be included in a housing approximately 48 inches long, 24 inches deep, and 30 inches high. And may weigh approximately 700 lbs.

Further, a medium to large system may be provided to produce 50,000 watts (400 amps) and provide enough electricity to power a very large American home or provide adequate power for an African type business strip complex with a medium size fabrication and repair shop. Such an implementation may be efficiently housed in a housing container approximately 60 inches long, 36 inches deep and 42 inches high and weigh approximately 1,200 lbs.

Moreover, a very large system may be provide to produce 100.000 watts (800 amps), which may be enough to power a range of small industries or, a very large African village complex with a larger size fabrication facility and repair shop. Such an implementation may be included in a housing approximately 72 inches long, 42 inches deep and 48 inches high and weigh approximately 1,200 lbs. Such an implementation may be particularly useful in that it may be included in a building to provide backup power for that building or it can be placed in a 10 ft. long×6 ft. wide×6 ft. high shipping container and transported, as is understood conventionally, via truck, rail or ship.

Much larger systems are also implementable to create 150,000 watts (1200 amps) of electricity. Such implementations may weigh over 2000 lbs. and may be placed in a building or can be placed in a 10 ft. long×8 ft. wide×8 ft. high shipping container (likewise transported, as is understood conventionally, via truck, rail or ship).

Moreover, a single unit can operated to be the sole supplier of electric power or a provider of multi-level electric power, wherein a single unit provides numerous different levels of electricity demand simultaneously as explained above.

Disclosed embodiments of the apparatus may be used as a standby electricity unit, or used to supplement electric power to an external on-grid electricity system to boost electricity demand thereto. Thus, disclosed embodiments may be used as a mechanism to stretch electrical power resources to address usage requirements (e.g., a summer heat wave triggering a brownout or blackout).

Disclosed embodiments may be utilized as stationary units or may be implemented as portable units that may be moved around to provide electric power within a geographic region, e.g., to supply electric power to a mobile hospital, aid or military organization to provide movable and transportable, self-operational, self-produced electric power generation.

Disclosed embodiments may provide electric power to isolated areas or facilities where on-grid electricity is not available, partially available or insufficient in level or reliability to support industrial, commercial, residential or humanitarian activities. Thus, the apparatus serves as a useful alternative source of electricity in developing third-world countries that cannot afford to set up costly large-scale electricity generating stations, or who do not have surplus funds to purchase electric power from other countries.

Accordingly, each of these implementations of the disclosed embodiments has utility to assist hindered communities by providing a more useful reliable continuous operation no-cost electric power. For example, the multi-function source of electric power can provide very affordable needed electricity to burdened nations and governments determined to progress forward and strive to lessen relentless humanitarian suffrage attributes.

In accordance with disclosed embodiments, once the units are turned on (powered up), the unit can provides power at no cost until such time that the components are degraded to a point that proper balance between the batteries and power generation components cannot be sustained.

The larger units may be contained in housing made of high quality industrial steel that is power coat painted. Smaller units may be provided with wheels that enable the units to roll on industrial quality inflatable rubber tire wheels for easy moving (with safety wheel break locks in place).

Although certain illustrative embodiments have been described in detail above, variations and modifications exist within the scope and spirit of this disclosure as described and as defined in the claims included in this application. Accordingly, all modifications, alterations add changes coming within the spirit and scope of the invention are herein meant to be included.

1. A self-contained unit for producing electric power using only components included within the unit, the unit comprising:
at least one battery;
at least one power inverter coupled to and supplying AC electricity to power at least one motor;
at least one permanent magnet dynamo coupled to the at least one motor and supplied by power from the at least one motor to operate the at least one permanent magnet dynamo to produce DC power to charge the at least one battery; and
at least one computer controlled regulator that regulates both an amount of DC power generated by the at least one permanent magnet dynamo, separates the power received by the at least one permanent magnet dynamo into different types of power by voltage and selectively disconnects coupling of the at least one battery from the permanent magnet dynamo to regulated balance power to the at least one battery,
wherein the at least one power inverter also supplies AC electricity to at least one electrical outlet.

2. The unit of claim 1, wherein the at least one power inverter is also coupled to and supplies AC electricity to at least one blower included in the unit.

3. The unit of claim 1, further comprising a fuse coupled between the at least one battery and the at least one computer controlled regulator.

4. The unit of claim 1, further comprising a plurality of electrical outlets configured and coupled to the other components of the unit to output the different types of power by voltage level and type.

5. The unit of claim 1, further comprising a heater placed in proximity to other components included in the housing to enable proper operation of the components.

6. The unit of claim 1, further comprising a housing incorporating the at least one battery, the at least one inverter, the at least one motor, the at least one regulator and the at least one PMD.

7. The unit of claim 1, coupled together with at least one other unit of claim 1 configured to provide electric power of different types and different levels.

8. The unit of claim 1, further comprising a plurality of internal system blower fans.

9. The unit of claim 1, further comprising a plurality of internal system unit heaters.

10. The unit of claim 1, wherein the unit includes a plurality of inverters each independently supplying AC electricity to a single AC motor.

11. The unit of claim 10, wherein the at least one permanent magnet dynamo is one of a plurality of permanent magnet dynamos included in the housing.

12. The unit of claim 1, wherein the at least one motor and the permanent magnet dynamo are coupled together via one or more belts.

13. The unit of claim 1, wherein the at least one motor and the permanent magnet dynamo are coupled together via a set of gears.

14. The unit of claim 1, wherein the at least one motor and the permanent magnet dynamo are coupled together via one or more chains.

15. The unit of claim 1, wherein the at least one inverter supplies AC power at levels including 12, 48, 72, 96, 110, 220, or 240 volts.

16. The unit of claim 15, wherein power output from the at least one electrical outlet ranges between 10 and 1,200 amps.

17. A method for producing electric power using only components included within a self-contained unit, the method comprising:
providing at least one battery;
providing at least one power inverter, coupling the at least one inverter to at least one motor and supplying the at least one motor with AC electricity to power the at least one motor; and
providing at least one permanent magnet dynamo, coupling the at least one permanent magnet dynamo to the at least one motor and supplying power from the at least one motor to operate the at least one permanent magnet dynamo to produce DC power to charge the at least one battery,
wherein at least one computer controlled regulator regulates both an amount of DC power generated by the at least one permanent magnet dynamo, separates the power received by the at least one permanent magnet dynamo into different types of power by voltage and selectively disconnects coupling of the at least one battery from the permanent magnet dynamo to regulated balance power to the at least one battery, and
wherein the at least one power inverter also supplies AC electricity to at least one electrical outlet.

18. The method of claim 17, wherein the at least one power inverter is also coupled to and supplies AC electricity to at least one blower included in the unit.

19. The method of claim 17, further comprising coupling the at least one battery to the at least one computer controlled regulator via a fuse.

20. The method of claim 17, further comprising coupling a plurality of electrical outlets to the other components of the unit to output the different types of power by voltage level and type.

21. The method of claim 17, wherein the unit includes a plurality of inverters each independently supplying AC electricity to a single AC motor.

22. The method of claim 17, wherein the at least one permanent magnet dynamo is one of a plurality of permanent magnet dynamos included in the housing.

23. The method of claim 17, wherein the at least one motor and the permanent magnet dynamo are coupled together via one or more belts.

24. The method of claim 17, wherein the at least one motor and the permanent magnet dynamo are coupled together via a set of gears.

25. The method of claim 17, wherein the at least one motor and the permanent magnet dynamo are coupled together via one or more chains.

26. The method of claim 17, wherein the at least one inverter supplies AC power at levels including 12, 48, 72, 96, 110, 220, or 240 volts.

27. The method of claim 17, wherein power output from the at least one electrical outlet ranges between 10 and 1,200 amps.
